(19) United States
(12) Patent Application Publication
(10) Pub. No.: US 2014/0164066 A1
(43) Pub. Date: Jun. 12, 2014

(54) Determining Efficient Assortments of Products

(71) Applicant: HEWLETT- PACKARD DEVEOPMENT COMPANY, L.P., Houston, TX (US)

(72) Inventors: Ruxian Wang, Palo Alto, CA (US); Julie A. Ward, Palo Alto, CA (US)

(73) Assignee: HEWLETT-PACKARD DEVEOPMENT COMPANY, L.P., Houston, TX (US)

(21) Appl. No.: 13/710,833

(22) Filed: Dec. 11, 2012

(51) Int. Cl. G06Q 10/06

(52) U.S. Cl. CPC G06Q 10/0637
USPC 705/7.36

(57) ABSTRACT

A plurality of efficient assortments may be determined for a plurality of products. One of the efficient assortments may be identified based on a strictly decreasing convex function.

### BACKGROUND

For manufacturers and retailers, having the right product offering can help to preserve and grow market share. A broad and diverse product offering can enable a firm to achieve good market reach. However, offering too many products can lead to high operational costs and poor execution, which can adversely impact market share, revenue, and profits. Additionally, consumers may be confused and frustrated by too broad selection of products. At the same time, having too few products, or a poor selection of products, can similarly frustrate customers and negatively impact market share for the firm.

### BRIEF DESCRIPTION OF DRAWINGS

The following detailed description refers to the drawings, wherein:

FIG. 1 illustrates a method of determining an optimal assortment of products for a product offering, according to an example.

FIG. 2 illustrates a method of determining a plurality of efficient assortments of products, according to an example.

FIG. 3 illustrates an example of determining an optimal assortment of products for a product offering, according to an example.

FIG. 4 illustrates a system configured to identify an optimal assortment of products for a product offering, according to an example.

FIG. 5 illustrates a computer-readable medium for determining an optimal assortment of products for a product offering, according to an example.

### DETAILED DESCRIPTION

Finding the right set of products to offer is a challenging problem called assortment optimization. One challenge comes from the fact that a firm should understand how customer demand is affected by the product offering. For example, if a customer does not find his first choice of product in a firm's offering, will he find an acceptable substitute among the firm's products, go to a competitor, or possibly decide not to purchase any product? Another challenge pertains to the large number of products that may be available for placement in a product portfolio. The problem may be considered “capacitated” if a limit is set for the number of products that may be in a firm's product offering.

In an example, a plurality of efficient assortments of a plurality of products can be determined. The plurality of products may include all of the products potentially available for offering by a firm. The plurality of efficient assortments may be determined by generating a linear function for each product, identifying intersection points among the linear functions, and selecting the top at most C linear functions according to a ranking of the intersection points. C can be the capacity constraint, that is, the maximum number of products that may be included in an efficient assortment. For example, the capacity constraint can be dictated by the amount of available shelf space for products. The determination of efficient assortments may be considered a visualization technique, in which a number of efficient assortments are visualized.

A strictly decreasing convex function may then be generated based on the efficient assortments. A unique fixed point of the strictly decreasing convex function may be identified, where the unique fixed point corresponds with one of the efficient assortments. This identified efficient assortment may be considered the optimal assortment of products for capacity constraint C. The assortment may be optimal in that it maximizes expected profit, expected revenue, or the like, according to the models underlying this technique. However, as used herein, “optimal” does not signify that the assortment must be objectively or subjectively optimal (e.g., the best). Rather, “optimal” is used herein to distinguish an assortment as preferred, according to the techniques described herein, relative to the other identified efficient assortments. Further details of this embodiment and associated advantages, as well as of other embodiments, will be discussed in more detail below with reference to the drawings.

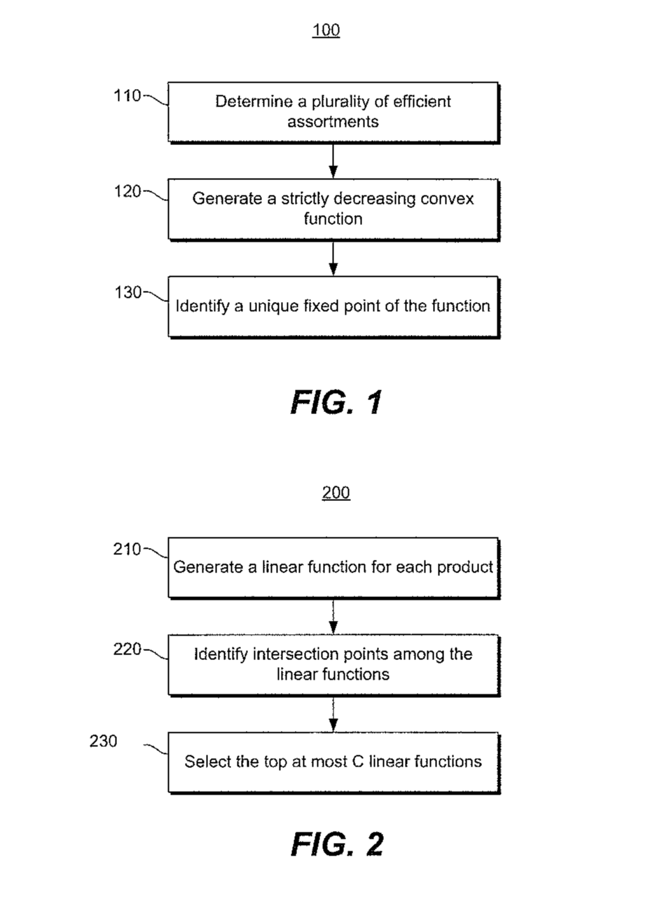

Referring now to the drawings, FIG. 1 illustrates a method 100 of determining an optimal assortment of products for a product offering, according to an example. Method 100 may be performed by a computing device, system, or computer, such as computing system 400 or computer 500. Computer-readable instructions for implementing method 100 may be stored on a computer readable storage medium. These instructions as stored on the medium may be called modules and may be executed by a computer.

At 110, a plurality of efficient assortments of a plurality of products may be determined. The plurality of products may correspond to a group of products that a firm (e.g., a business, an enterprise, an individual, a partnership) is considering offering for sale. For example, if the firm sells information technology products, the plurality of products may include computers, servers, routers, software, or the like. The plurality of products may be limited to a specific market segment such that the products are considered substitutable. Two products are substitutable if a customer could reasonably purchase one of the products in place of the other product and still meet the customer's needs. For example, the plurality of products may include only products from a broad category, such as computers, or only products from a narrower category, such as laptops or certain classes of laptops.

The plurality of efficient assortments of the plurality of products may be determined based on one or more mathematical models. For example, the basic attraction model (BAM) can be used. The Multinomial Logit (MNL) model and the Nested Logit (NL) model are special cases of the basic attraction model and have been derived from an underlying maximum random utility model, which is based on a probabilistic model of individual customer utility. The attraction model can describe purchase behavior of customers facing multiple substitutable products in many scenarios.

However, the BAM may be too optimistic in estimating demand recapture probabilities when a customer's first choice is not in the offer set. In contrast, the independent demand model may be too pessimistic because it completely ignores substitution. To overcome these drawbacks, the generalized attraction model (GAM) may be used.

The GAM may be described as follows. Suppose the product set in consideration is M={1,2, . . . , m}. Denote the attraction value of product iεM as vᵢ and assume without loss of generality that the attractiveness of non-purchase alternative is normalized to 1. In addition, there are switching costs wᵢε[0, vᵢ], or often called distraction value in the attraction model, for each product i not offered in the assortment. Given offer set S, customers will purchase product i with probability:

$${π}_{i} ( S ) = \frac{{v}_{i}}{1 + {\sum }_{k ∈ S}^{ } {v}_{k} + {\sum }_{k ∈ \overline{S}}^{ } {w}_{k}} , \qquad ( 1 )$$

where S̅=M\S:={k: kεM, k∉S}. The non-purchase probability is

$${π}_{0} ( S ) = \frac{{v}_{0} + {\sum }_{k ∈ \overline{S}}^{ } {w}_{k}}{1 + {\sum }_{k ∈ S}^{ } {v}_{k} + {\sum }_{k ∈ \overline{S}}^{ } {w}_{k}} .$$

When wᵢ=0 for all i, the GAM reduces to the BAM formulation; when wᵢ=vᵢ for all i, the purchase probability of each product doesn't change with the offer set S and this is the independent demand model. The parsimonious formulation is defined if the switching cost wᵢ is the same proportion of its attraction value vᵢ for each product iεM, i.e., wᵢ=θvᵢ for all i, where θ is a constant and θε[0,1].

An alternative way to define the GAM formulation is provided as follows

$${π}_{i} ( S ) = \frac{{\tilde{v}}_{i}}{1 + {\sum }_{k ∈ S}^{ } {\tilde{w}}_{k}} , ∀ i ∈ S , \\ {π}_{0} ( S ) = 1 - {\sum }_{i ∈ S}^{ } {π}_{i} ( S ) ,$$

where

$${\tilde{v}}_{i} = \frac{{v}_{i}}{1 + {\sum }_{k = 1}^{m} {w}_{k}}$$

$$and$$

$${\tilde{w}}_{i} = \frac{{v}_{i} - {w}_{i}}{1 + {\sum }_{k = 1}^{m} {w}_{k}}$$

for all iεM.

The plurality of efficient assortments may be limited by a capacity constraint. The capacity constraint may be dictated by business needs or may be selected for other reasons. For example, the shelf space in a grocery store may be limited, an online advertising company may have a limited number of locations on a web page where ads can appear, or a manufacturer may have a budget constraint on the number of product lines to operate.

The assortment problem with a capacity constraint may be considered under the GAM formulation as follows. The goal may be to find the assortment among all the products in consideration M with size at most C to maximize the total expected revenue or profit, depending on the business objective. To avoid trivial cases, assume that C≦m. Denote pᵢ as the price or margin of product i per unit. The capacitated assortment problem can be formulated as follows:

$${max}_{S ⊆ M} R ( S ) {=}^{def} {\sum }_{i ∈ S}^{ } {p}_{i} {π}_{i} ( S ) , \\ s . t . , \vert S \vert \leq C , \qquad ( 2 )$$

where |5| denotes the cardinality of S and πᵢ(S) follows the GAM formulation defined in equation (1).

Problem (2) is a combinatorial optimization problem and the number of subsets S⊂M to evaluate is (₁^{m})+(₂^{m})+ . . . +(_{C}^{m}), which is in the same order of 2^{m} when C is not too small. As such, the problem may be intractable for large m. Accordingly, the inventors devised a method of reducing the search space to facilitate solution of problem (2), as shown in FIG. 2, in order to determine the plurality of efficient assortements for use in method 100.

FIG. 2 illustrates a method 200 of determining the plurality of efficient assortments of products, according to an example. Method 200 may be performed by a computing device, system, or computer, such as computing system 400 or computer 500. Computer-readable instructions for implementing method 200 may be stored on a computer readable storage medium. These instructions as stored on the medium may be called modules and may be executed by a computer.

At 210, a linear function may be generated for each product. At 220, intersection points among the linear functions may be identified. At 230, the top at most C linear functions may be selected. The linear functions may be selected based on a ranking of the intersection points. The products corresponding to the top at most C linear functions may constitute an efficient assortment. Efficient assortments may be determined over a plurality of intervals. The intervals may be defined by the intersection points. Method 200 will now be described in more detail.

Method 200 may be considered a way to visualize the efficient assortment. It also assists the determination of an optimal assortment, as described in more detail later. Additionally, method 200 allows the discovery of the relationship among the parameters in the GAM formulation. The inventors determined that problem (2) can be expressed as follows:

$$max \{ γ ∈ ℛ \text{:} \vert S \vert \leq C and {\sum }_{i ∈ S}^{ } \frac{{p}_{i} {v}_{i}}{1 + {\sum }_{k ∈ S}^{ } {v}_{k} + {\sum }_{k ∈ \overline{S}}^{ } {w}_{k}} \geq γ \} \\ ⇔ max \{ γ ∈ ℛ \text{:} \vert S \vert \leq C and {\sum }_{i ∈ S}^{ } ( {p}_{i} {v}_{i} - ( {v}_{i} - {w}_{i} ) γ ) \geq ( 1 + {\sum }_{k = 1}^{m} {w}_{k} ) γ \} \\ ⇔ max \{ γ ∈ ℛ \text{:} \vert S \vert \leq C and {\sum }_{i ∈ S}^{ } ( {p}_{i} {\tilde{v}}_{i} - {\tilde{w}}_{i} γ ) \geq γ \} ,$$

where

$${\tilde{v}}_{i} = \frac{{v}_{i}}{1 + {\sum }_{k = 1}^{m} {w}_{k}}$$

$$and$$

$${\tilde{w}}_{i} = \frac{{v}_{i} - {w}_{i}}{1 + {\sum }_{k = 1}^{m} {w}_{k}} .$$

In the BAM formulation, \tilde{v}ᵢ=vᵢ and \tilde{w}ᵢ=vᵢ for all iεM. For the parsimonious GAM formulation,

$${\tilde{v}}_{i} = \frac{{v}_{i}}{1 + θ {\sum }_{k = 1}^{m} {v}_{k}}$$

$$and$$

$${\tilde{w}}_{i} = \frac{( 1 - θ ) {v}_{i}}{1 + θ {\sum }_{k = 1}^{m} {v}_{k}}$$

for all iεM.

Let the linear function hᵢ: [symbol] → [symbol] for all iεM be defined by:

h₀(γ)=0,

hᵢ(γ)pᵢ\tilde{v}ᵢ−\tilde{w}ᵢγ, ∀iεM. (3)

For each pair of hᵢ(γ) and hᵢ(γ) with pᵢ\tilde{v}ᵢ>pⱼ\tilde{v}ⱼ and \tilde{w}ᵢ>\tilde{w}ⱼ, i≠j, let [symbol] _{i,j} denote the x-coordinate of the intersection point between the lines hᵢ(γ) and hⱼ(γ):

$${𝒜}_{i , j} = \frac{{p}_{i} {\tilde{v}}_{i} - {p}_{j} {\tilde{v}}_{j}}{{\tilde{w}}_{i} - {\tilde{w}}_{j}} .$$

The number of intersection points among the m+1 lines is at most (₂^{m+1})=m(m+1)/2. Let τ=((i₁, j₁) . . . , (i_{K}, J_{K})) denote the ranking of the intersection points with positive values in ascendent order:

0= [symbol] ᵢ_{_{o,}}ⱼ_{₀}< [symbol] ᵢ_{_{1,}}ⱼ_{₁}≦ . . . ≦ [symbol] ᵢ_{_{K,}}ⱼ_{K}< [symbol] ᵢ_{_{k+1,}}ⱼ_{K+1}=∞.

Two end points [symbol] ᵢ_{_{0,}}ⱼ_{₀} and [symbol] ᵢ_{_{K+1,}}ⱼ_{_{K+1}} may be added. Because there is no intersection in any consecutive pair [symbol] ᵢ_{_{ι,}}ⱼ_{_{ι}} and [symbol] ᵢ_{_{ι+1,}}ⱼ_{_{ι+1}}, the lines can be ranked from the highest to the smallest values (desscending order) σ^{ι}=(σ₁^{ι}, . . . , σₘ^{ι}), i.e., for any γε( [symbol] ᵢ_{_{ι,}}ⱼ_{_{ι}}, [symbol] ᵢ_{_{ι+1,}}ⱼ_{_{ι+1}}], and the ranking doesn't change within each interval, i.e.,

h_{σ}_{₁}_{^{ι}}(γ)≧h_{σ}_{₂}_{^{ι}}(γ)≧ . . . ≧h_{σ}_{ₘ}_{^{ι}}(γ), γε( [symbol] ᵢ_{_{ι,}}ⱼ_{_{ι}}, [symbol] ᵢ_{_{ι+1}}_{, j}_{_{ι+1}}].

Accordingly, the following definition follows:

Definition 1 (Efficient Assortment) Let set S_{C}^{ι} correspond to the first at most C elements with positive values according to the ordering σ^{ι}, i.e., S_{C}^{ι}={σ₁^{ι}, . . . , σ_{C}_{_{ι}}_{^{*}}^{ι}} and C_{ι}_{^{*}} =max{C′:C′≦C, h_{σ}_{_{C′}}_{^{ι}}(γ)>0f or γε( [symbol] ᵢ_{_{ι,}}ⱼ_{_{ι}}, [symbol] ᵢ_{_{ι+1,}}ⱼ_{_{ι+1}})}. Set S_{C}^{ι} is called the efficient assortment for any γε( [symbol] ᵢ_{_{ι,}}ⱼ_{_{ι}}, [symbol] ᵢ_{_{ι+1,}}ⱼ_{_{ι+1}}).

The efficient assortment in Definition 1 is related to the concept of efficient set in the context of revenue management. For each γ, there exists a unique ι such that γε( [symbol] ᵢ_{_{ι,}}ⱼ_{_{ι}}, [symbol] ᵢ_{_{ι+1,}}ⱼ_{_{ι+1}}]. The corresponding assortment S_{C}^{ι} may be called an efficient assortment, and the optimal assortment is thus in the set {S_{C}^{ι}, ι=0,1, . . . , K}. Accordingly, it appears that there are at most m(m+1)/2 efficient assortments. Furthermore, there are at most C(m−C+1) distinct efficient assortments in the GAM formulation.

Returning to method 100, at 120 a strictly decreasing convex function may be generated based on the identified efficient assortments. For example, the strictly decreasing convex function may be generated based on the top at most C linear functions, where C is the capacity constraint. In particular, the strictly decreasing convex function may be defined as a sum of the top at most C linear functions for each interval. At 130, a unique fixed point of the strictly decreasing convex function may be identified. The unique fixed point corresponds with one of the efficient assortments. The efficient assortment corresponding to the unique fixed point may be considered to be the optimal assortment. For example, the assortment may be optimal in that it maximizes expected profit.

The strictly decreasing convex function may be defined as follows. Define a new function [symbol] (γ) as the sum of the values of the top C_{ι}* functions for each γ, i.e.,

$$ℋ ( γ ) = {max}_{\vert S \vert \leq C} {\sum }_{i ∈ S} {p}_{i} {\tilde{v}}_{i} - {\tilde{w}}_{i} γ .$$

More explicitly, because the ranking of the lines doesn't change for all γ between any two consecutive intersections, [symbol] (γ) can be rewritten as follows:

[symbol]

(γ)=Σ_{iεS}_{_{C}}_{^{ι}} pᵢ\tilde{v}ᵢ−\tilde{w}ᵢγ, ∀γε( [symbol] ᵢ_{_{ι,}}ⱼ_{_{ι}}, [symbol] ᵢ_{_{ι+1,}}ⱼ_{_{ι+1}}].

Because function [symbol] (γ) is piecewise linear in γ, the following theorem follows: Theorem 1 [symbol] (γ) is strictly decreasing convex in γ for γ≦ [symbol] ᵢ_{_{K,}}ⱼ_{_{K}} and there is a unique solution to [symbol] (γ)=γ, denoted by γ*. The corresponding efficient assortment S_{C}^{ι*} is optimal and the optimal profit is equal to γ*, i.e., R(S_{C}^{ι*})=γ*.

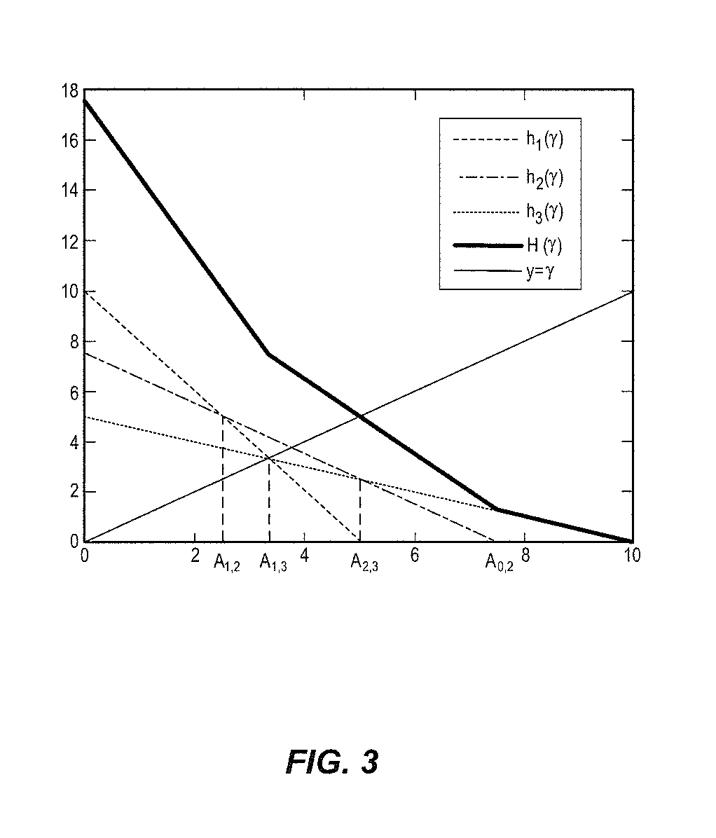

FIG. 3 illustrates an example of determining an optimal assortment of products for a product offering, according to an example. In particular, FIG. 3 illustrates how the efficient assortments can be visualized. Consider three products (m=3) with parameters in the GAM formulation as follows:

p₁\tilde{v}₁=10, \tilde{w}₁=2; p₂\tilde{v}₂=7.5, \tilde{w}₂=1; and p₃\tilde{v}₃=5, \tilde{w}₃=0.5.

The capacity constraint is C=2. Thus, the hᵢ(·) functions (i.e., the linear functions for each product) are the following:

h₁(γ)=10−2γ, h₂(γ)=7.5−γ, h₃(γ)=5−0.5γ.

Each of these functions is shown in FIG. 3. Then, the intersection points among the four functions, including h₀(γ)=0, can be identified as follows: [symbol]
_{1,2}=2.5, [symbol] _{1,3}=3.33, [symbol] _{0,1}= [symbol] _{2,3}=5, [symbol] _{0,3}=7.5, [symbol] _{0,3}=10.
As can be seen, by selecting the top at most 2 linear functions according to a ranking of the intersection points, the efficient assortment includes products 1 and 2 for γε(0, [symbol] _{1,3}], products 2 and 3 for γε( [symbol] _{1,3}, [symbol] _{0,2}], and product 3 for γε( [symbol] _{0,2}, [symbol] _{0,3}). By adding together the corresponding functions for each efficient assortment over the identified intervals, function [symbol] (γ) (i.e., the strictly decreasing convex function) can be rewritten as follows:

$$ℋ ( γ ) = \{ \begin{matrix}17.5 - 3 γ , & 0 < γ \leq 3.33 , \\ 12.5 - 1.5 γ , & 3.33 < γ \leq 7.5 , \\ 5 - 0.5 γ , & 7.5 < γ \leq 10.\end{matrix}$$

The unique solution to [symbol] (γ)=γ (i.e., the unique fixed point) is γ*=5. Thus, the corresponding assortment, which contains products 2 and 3, can be considered to be optimal.

A method of finding the unique solution to [symbol] (γ)=γ will now be described. It is noted that intersection notations [symbol] (i,j) and [symbol] _{i,j} are interchanged to avoid a higher level of subscripts. Since [symbol] (γ) is decreasing convex in γ, the following efficient algorithm may be developed based on the bi-section search algorithm to search over all distinct efficient intervals for the one, denoted by ( [symbol] (i_{ι*}, j_{ι*}), [symbol] (i_{ι*+1}, j_{ι*+1})]. that contains γ*, the solution to [symbol] (γ)=γ. This may be done in iterations of order of 0(log((m−C)C)). Additionally, [symbol] (γ)−γ=0, γε( [symbol] (i_{_{ι*}}, j_{ι*}), [symbol] (i_{ι*+1}, j_{ι*+1}) may be solved as a result. Because [symbol] (γ) is linear in ( [symbol] (i_{ι*}, j_{ι*}), [symbol] (i_{ι*+1}, j_{ι*+1})], there is a unique solution in closed form.

The method may be described as follows. In iteration ι, denote the search set

$$〈 A ( {i}_{l} , {j}_{l} ) , A ( {i}_{l ′} , {j}_{l ′} , ) 〉 {=}^{def} \{ ( A ( {i}_{l} , {j}_{l} ) , A ( {i}_{l + 1} , {j}_{l + 1} ) ] , … , ( A ( {i}_{l ′ - 1} , {j}_{l ′ - 1} ) , A ( {i}_{l ′} , {j}_{l ′} ) ] \} .$$

Algorithm: Assortment-GAM: In iteration ι, select the middle intersection point, denoted by

$$A ( {i}_{⌊ \frac{l + l ′}{2} ⌋} , {j}_{⌊ \frac{l + l ′}{2} ⌋} ) ,$$

where └x┘ represent the largest integer that is less than or equal to x. Check whether γ* is located in the interval

$$( A ( {i}_{⌊ \frac{l + l ′}{2} ⌋} , {j}_{⌊ \frac{l + l ′}{2} ⌋} ) , A ( {i}_{⌊ \frac{l + l ′}{2} ⌋ + 1} , {j}_{⌊ \frac{l + l ′}{2} ⌋ + 1} ) ] \text{:}$$

1. If

$$H ( γ ) - γ {\vert}_{γ = A ( {i}_{⌊ \frac{l + {l}^{′}}{2} ⌋} , {j}_{⌊ \frac{l + {l}^{′}}{2} ⌋} )} < 0 ,$$

the optimal interval is at the left of

$$A ( {i}_{⌊ \frac{l + {l}^{′}}{2} ⌋} , {j}_{⌊ \frac{l + {l}^{′}}{2} ⌋} )$$

and the search set of intervals in iteration ι+1 is updated as follows:

$$〈 A ( {i}_{l} , {j}_{l} ) , A ( {i}_{⌊ \frac{l + {l}^{′}}{2} ⌋} , {j}_{⌊ \frac{l + {l}^{′}}{2} ⌋} ) 〉 {=}^{def} \{ ( A ( {i}_{l} , {j}_{l} ) , A ( {i}_{l + 1} , {j}_{l + 1} ) ] , ( A ( {i}_{l + 1} , {j}_{l + 1} ) , A ( {i}_{l + 2} , {j}_{l + 2} ) ] , … , ( A ( {i}_{⌊ \frac{l + {l}^{′}}{2} ⌋ - 1} , {j}_{⌊ \frac{l + {l}^{′}}{2} ⌋ - 1} ) , A ( {i}_{⌊ \frac{l + {l}^{′}}{2} ⌋} , {j}_{⌊ \frac{l + {l}^{′}}{2} ⌋} ) ] \} ;$$

2. If

$$H ( γ ) - γ {\vert}_{γ = A ( {i}_{⌊ \frac{l + {l}^{′}}{2} ⌋ + 1} , {j}_{⌊ \frac{l + {l}^{′}}{2} ⌋ + 1} )} > 0 ,$$

the optimal interval is at the right hand side of

$$A ( {i}_{⌊ \frac{l + {l}^{′}}{2} ⌋ + 1} , {j}_{⌊ \frac{l + {l}^{′}}{2} ⌋ + 1} )$$

and the search set of intervals in iteration ι+1 is updated as follows

$$〈 A ( {i}_{⌊ \frac{l + {l}^{′}}{2} ⌋ + 1} , {j}_{⌊ \frac{l + {l}^{′}}{2} ⌋ + 1} ) , A ( {i}_{{l}^{′}} , {j}_{{l}^{′}} ) 〉 {=}^{def} \{ ( A ( {i}_{⌊ \frac{l + {l}^{′}}{2} ⌋ + 1} , {j}_{⌊ \frac{l + {l}^{′}}{2} ⌋ + 1} ) , A ( {i}_{⌊ \frac{l + {l}^{′}}{2} ⌋ + 2} , {j}_{⌊ \frac{l + {l}^{′}}{2} ⌋ + 2} ) ] , … , ( A ( {i}_{l ′ - 1} , {j}_{{l}_{l ′} - 1} ) , A ( {i}_{l ′} , {j}_{l ′} ) ] \} ;$$

3. Otherwise, terminate with the interval

$$( A ( {i}_{⌊ \frac{l + {l}^{′}}{2} ⌋} , {j}_{⌊ \frac{l + {l}^{′}}{2} ⌋} ) , A ( {i}_{⌊ \frac{l + {l}^{′}}{2} ⌋ + 1} , {j}_{⌊ \frac{l + {l}^{′}}{2} ⌋ + 1} ) ]$$

and the corresponding assortment

$${S}_{C}^{{i}_{⌊ \frac{l + {l}^{′}}{2} ⌋}} .$$

The Assortment-GAM algorithm finds the optimal assortment S_{C}ⁱ^{_{ι*}} and the corresponding interval ( [symbol] (i_{ι*}, j_{ι*}), [symbol] (_{ι*+1}, j_{ι*+1})] in a number of iterations of order 0(log((m−C)C)).

For the efficient assortments {S_{C}^{ι}, ι=0,1, . . . , K} corresponding to the ranking of intersection points [symbol] ᵢⱼ, define the Q(S_{C}^{γ})=Σ_{kεS}_{_{C}}_{^{ι}}πₖ(S_{C}^{ι}), the total probability of purchasing a product in assortment S_{C}^{ι}.
Proposition 1 R(S_{C}^{ι}) and Q(S_{C}^{ι}) are uni-modal with respect to ι in the GAM formulation. Moreover, Q(S_{c}^{ι}) is decreasing with respect to ι in the parsimonious GAM formulation.

Profit function R(S_{c}^{ι}) is increasing in ι for ι≦ι* and is decreasing in ι for ι≧ι*. The assortments corresponding to ι<ι* are not efficient in any sense under the parsimonious GAM formulation because they consume more resource but produce less profit.

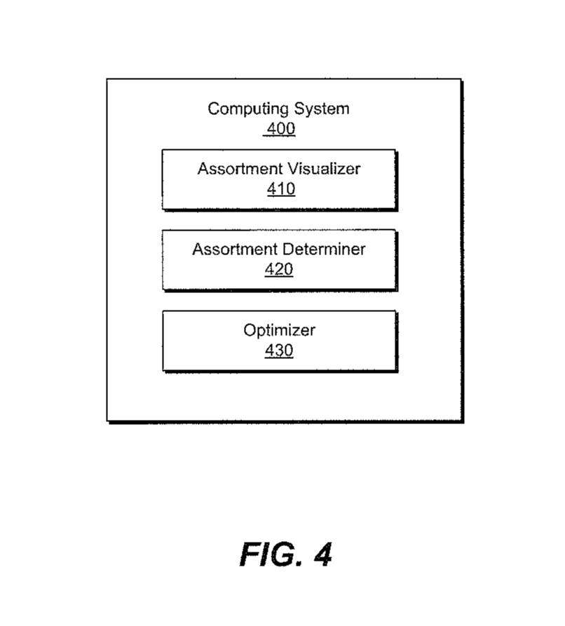

FIG. 4 illustrates a system configured to identify an optimal assortment of products for a product offering, according to an example. Computing system 400 may include and/or be implemented by one or more computers. For example, the computers may be server computers, workstation computers, desktop computers, or the like. The computers may include one or more controllers and one or more machine-readable storage media.

A controller may include a processor and a memory for implementing machine readable instructions. The processor may include at least one central processing unit (CPU), at least one semiconductor-based microprocessor, at least one digital signal processor (DSP) such as a digital image processing unit, other hardware devices or processing elements suitable to retrieve and execute instructions stored in memory, or combinations thereof. The processor can include single or multiple cores on a chip, multiple cores across multiple chips, multiple cores across multiple devices, or combinations thereof. The processor may fetch, decode, and execute instructions from memory to perform various functions. As an alternative or in addition to retrieving and executing instructions, the processor may include at least one integrated circuit (IC), other control logic, other electronic circuits, or combinations thereof that include a number of electronic components for performing various tasks or functions.

The controller may include memory, such as a machine-readable storage medium. The machine-readable storage medium may be any electronic, magnetic, optical, or other physical storage device that contains or stores executable instructions. Thus, the machine-readable storage medium may comprise, for example, various Random Access Memory (RAM), Read Only Memory (ROM), flash memory, and combinations thereof. For example, the machine-readable medium may include a Non-Volatile Random Access Memory (NVRAM), an Electrically Erasable Programmable Read-Only Memory (EEPROM), a storage drive, a NAND flash memory, and the like. Further, the machine-readable storage medium can be computer-readable and non-transitory. Additionally, computing system 400 may include one or more machine-readable storage media separate from the one or more controllers.

Computing system 400 may include assortment visualizer 410, assortment determiner 420, and optimizer 430. Each of these components may be implemented by a single computer or multiple computers. The components may include software modules, one or more machine-readable media for storing the software modules, and one or more processors for executing the software modules. A software module may be a computer program comprising machine-executable instructions.

In addition, users of computing system 400 may interact with computing system 400 through one or more other computers, which may or may not be considered part of computing system 400. As an example, a user may interact with system 400 via a computer application residing on another computer, such as a desktop computer, workstation computer, tablet computer, or the like.

The functionality implemented by assortment visualizer 410, assortment determiner 420, and optimizer 430 may be part of a larger software platform, system, application, or the like. For example, these components may be part of a product portfolio management software application.

Assortment visualizer 410, assortment determiner 420, and optimizer 430 may be configured to implement methods 100 and 200, or variations thereof, as described above. For example, assortment visualizer 410 may generate a linear function for each product of a plurality of products. Assortment determiner 420 may determine a plurality of efficient assortments of the plurality of products subject to a capacity constraint. Optimizer 430 may identify one of the plurality of efficient assortments as an optimal assortment based on a strictly decreasing convex function.

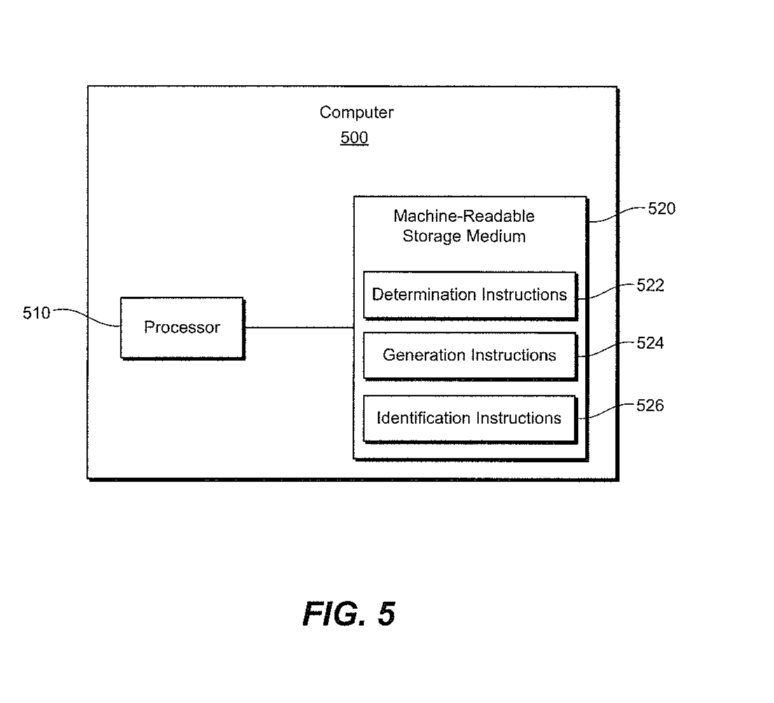

FIG. 5 illustrates a computer-readable medium for determining an optimal assortment of products for a product offering, according to an example. Computer 500 may be any of a variety of computing devices or systems, such as described with respect to computing system 400.

Processor 510 may be at least one central processing unit (CPU), at least one semiconductor-based microprocessor, other hardware devices or processing elements suitable to retrieve and execute instructions stored in machine-readable storage medium 520, or combinations thereof. Processor 510 can include single or multiple cores on a chip, multiple cores across multiple chips, multiple cores across multiple devices, or combinations thereof. Processor 510 may fetch, decode, and execute instructions 522, 524, 526, among others, to implement various processing. As an alternative or in addition to retrieving and executing instructions, processor 510 may include at least one integrated circuit (IC), other control logic, other electronic circuits, or combinations thereof that include a number of electronic components for performing the functionality of instructions 522, 524, 526. Accordingly, processor 510 may be implemented across multiple processing units and instructions 522, 524, 526 may be implemented by different processing units in different areas of computer 500.

Machine-readable storage medium 520 may be any electronic, magnetic, optical, or other physical storage device that contains or stores executable instructions. Thus, the machine-readable storage medium may comprise, for example, various Random Access Memory (RAM), Read Only Memory (ROM), flash memory, and combinations thereof. For example, the machine-readable medium may include a Non-Volatile Random Access Memory (NVRAM), an Electrically Erasable Programmable Read-Only Memory (EEPROM), a storage drive, a NAND flash memory, and the like. Further, the machine-readable storage medium 520 can be computer-readable and non-transitory. Machine-readable storage medium 520 may be encoded with a series of executable instructions for managing processing elements.

The instructions 522, 524, 526, when executed by processor 510 (e.g., via one processing element or multiple processing elements of the processor) can cause processor 510 to perform processes, for example, methods 100 and 200, and variations thereof. Furthermore, computer 500 may be similar to computing system 400 and may have similar functionality and be used in similar ways, as described above. For example, determination instructions 522 can cause processor 510 to determine a plurality of efficient assortments of a plurality of products. Generation instructions 524 can cause processor 510 to generate a strictly decreasing convex function based on the efficient assortments over a plurality of intervals. Identification instructions 526 can cause processor 510 to identify a unique fixed point of the function, the unique fixed point corresponding to one of the efficient assortments that optimizes an expected profit.

What is claimed is:

1. A method comprising:
determining a plurality of efficient assortments of a plurality of products;
generating a strictly decreasing convex function based on the efficient assortments;
identifying a unique fixed point of the function, wherein the unique fixed point corresponds with one of the efficient assortments.

2. The method of claim 1, wherein the plurality of efficient assortments is determined using the generalized attraction model.

3. The method of claim 1, wherein the plurality of efficient assortments are limited by a capacity constraint.

4. The method of claim 1, wherein determining the plurality of efficient assortments comprises:
generating a linear function for each product;
identifying intersection points among the linear functions; and
selecting the top at most C linear functions according to a ranking of the intersection points.

5. The method of claim 4, wherein the strictly decreasing convex function is generated based on the top at most C linear functions.

6. The method of claim 5, wherein the strictly decreasing convex function is defined as a sum of the top at most C linear functions for each interval.

7. The method of claim 4, wherein the intersection points are ranked in ascending order.

8. The method of claim 1, wherein the unique fixed point corresponds to an optimal expected profit among all of the efficient assortments.

9. A computing system, comprising:
an assortment visualizer to generate a linear function for each product of a plurality of products;
an assortment determiner to determine a plurality of efficient assortments of the plurality of products subject to a capacity constraint; and
an optimizer to identify one of the plurality of efficient assortments as an optimal assortment based on a strictly decreasing convex function.

10. The computing system of claim 9, wherein the assortment visualizer is configured to determine the linear function for each product based on an attraction value, a switching cost, and a price or margin per unit of each product.

11. The computing system of claim 9, wherein the number of products in each efficient assortment is no more than the capacity constraint.

12. The computing system of claim 9, wherein the assortment determiner is configured to determine the plurality of efficient assortments by identifying and ranking intersection points of the linear functions.

13. The computing system of claim 9, wherein the assortment determiner is configured to identify products for inclusion in each of the efficient assortments by selecting the top ranked at most C products over a plurality of intervals, wherein C is equal to the capacity constraint and the plurality of intervals is equal to the number of efficient assortments.

14. The computing system of claim 9, wherein the optimizer is configured to identify the optimal assortment by identifying a unique fixed point of the strictly decreasing convex function.

15. A non-transitory computer-readable storage medium comprising instructions that, when executed by a processor, cause the processor to
determine a plurality of efficient assortments of a plurality of products;
generate a strictly decreasing convex function based on the efficient assortments over a plurality of intervals;
identify a unique fixed point of the function, wherein the unique fixed point corresponds with one of the efficient assortments that optimizes a total expected profit.
